(19) United States
(12) Patent Application Publication
(10) Pub. No.: US 2012/0073691 A1
(43) Pub. Date: Mar. 29, 2012

(54) Dynamic vortex dropshaft water feature

(76) Inventors: Allen Lynn Davis, Corvallis, OR (US); Dale Joy Romrell, Corvallis, OR (US)

(21) Appl. No.: 12/924,285

(22) Filed: Sep. 23, 2010

(51) Int. Cl. F15C 1/16

(52) U.S. Cl. 137/808

(57) ABSTRACT

There is a dynamic vortex water feature having an upper vessel and a lower vessel for containing water. A vertical pipe extends from the bottom of the upper vessel and is attached at a lower end to a sump pump that is located interior to the lower vessel. A vortex generator is attached at an opening of the upper vessel and is in fluid communication with a transparent dropshaft. The dropshaft is approximate the length of and parallel to the vertical pipe. The sump pump pumps water from the lower vessel up the vertical pipe and into the upper vessel. Water flows from the vortex generator entering the dropshaft tangentially thereby creating a spirally of the water which leads to a variety of vortex induced bubble patterns that constantly change during the filling and emptying cycle of the vortex water feature.

### FIELD OF THE INVENTION

The present invention relates to a water feature and more particularly to a columnar water feature that displays an ever-changing vortex created within a clear column.

### BACKGROUND OF THE INVENTION

Water features are seen in many settings such as dental offices, hotel lobbies, outdoor art displays, and personal residences. Some common functions of water features are to mesmerize, relax, or entertain the viewer. Typically, these water features are in the form of a fountain or water fall using interesting rock, metal or ceramic sculpturing for the water to cascade over. Another form of water feature displays a fixed volume of water in a tube that is stirred by a mechanical means at the bottom. A vortex shape forms and a partial air column (a free surface) will be drawn down from the top. Other fixed-volume displays exist where a pump is used to draw water out of the bottom of a tube and the water is reintroduced tangentially, either at the top or the bottom of the tube creating a swirling effect, or vortex, within the tube.

One example of such a water feature is the Discovery Magazine's Desktop Vortex Device. This water feature has colored LED lights that change color over approximately a 30 second cycle and a small propeller located in the bottom-center of the device creates a stable, conically-shaped vortex that extends to the water surface. This device is available only in a 15 inch high model and lacks variety as the only changing effect is the lighting—the vortex is intended to remain in an air-free, nearly constant shape at a significantly full level.

A British artist/designer, William Pye, makes water features that also use the vortex shape as a special feature within a clear vertical column. His most notable work is a very large fountain named “Charybdis” located in Seaham Hall, Underland, UK. The fountain was manufactured in Colorado in 2000. His fountains feature a smooth vortex created as the water enters from the bottom of the column. According to a controlled system, the water level rises and falls within a clear, topless vertical column. An important element of this design is avoidance of entrained air. Unfortunately, without a certain amount of entrained air, visibility of the vortex that forms at the center of the vertical water column is limited or non-existent. Pye meticulously attempts to avoid air entrainment in order to maintain a smooth vortex, which is the dominant visual attraction of his device. The vortex in Pye's water feature is generated at the bottom of the column precluding the possibility of entrained air through a hydraulic pump or falling through a vertical tube. Although very attractive, the visible vortex is essentially the same throughout the cycle of the water feature and, as it is a custom art piece, is extremely expensive.

Another water feature of Mr. Pye's is located in London. This piece called

“Aquabar” is located in the departure lounge of Gatwick Airport, and comprises three transparent vessels of different diameters, where water rises and falls in sophisticatedly controlled and programmed cycles. As the water enters from the bottom of each of the glass vessels, a vortex forms in each vessel and water finally overflows the perimeter edge to ripple down the vertical sides. This water feature is very similar to “Charybis” previously discussed with multiple columns. Although this is a beautiful art piece, it is designed for one look at one particular destination, constructed from extremely expensive custom glass, and has a control system that is likely very expensive in order to maintain the controlled look Mr. Pye seeks for this art piece.

U.S. Pat. No. 7,245,561 issued to James David Coleman on Jul. 17, 2007, is for a vortex water feature that functions as a time telling device. In this invention, the vortex is generated and maintained by pumping water tangentially into the bottom of the vessel and by simultaneously controlling the water to flow out of a drain located in the middle of the bottom of the vessel. The water feature consists of annular cylinders (vertical pipes) where the water surface changes from empty to full over a one-hour period in the inner cylinder while the water surface in the outer annulus varies from empty to full over a 24 hour period. The inspection of the device at any moment in time yields an indication of time-of-day. The vortex in the inner cylinder is caused by water evacuating through the bottom-center of the inner cylinder. Therefore, to attain the desired time-dependent effect, the pumping rate must be carefully controlled using sophisticated control valves and the quantity of water must be kept at a constant level. Likewise, the water surface in the outer annulus must be controlled using valves whose opening angle is adjusted over time. Coleman describes multiple control schemes to produce the time-dependent display. Although Coleman makes mention of air bubbles making an attractive effect, any attempt to input air would potentially make it more difficult to see the upper surface, thus reliably determine the time of day. The controls required to make this device accurate and therefore useful make it both expensive and limited to a particular design size.

To maximize the mesmerizing effect of a vortex water feature, random introduction of air within the vortex as it fills and empties presents a multitude of visual effects. Having the ability to easily change the empty/fill rate according to the user's preferences and desired visual effects makes a water feature flexible unlike the stationary or fixed systems described above.

It is desirable to have a system that displays an ever-changing vortex that is both scalable according to the size of the application and adjustable according to the desired visual effects of the user. Additionally, this system needs to be simplistic with regard to design, therefore inexpensive to manufacture. A system that is also easily size-variable makes it useful for a wide range of applications from as small as a desktop to as large as a shopping mall display.

### SUMMARY OF THE INVENTION

The water feature of the present invention utilizes a vortex to create different and changing bubble patterns in a water display for lobbies, offices, and home applications as a completely unique piece of art creating interest, mesmerizing sounds, and relief for the stress and anxiety which is often inherent in medical, dental, and hospital-type environments.

It is the primary objective of the present invention to provide a dynamic vortex water feature where as the water level changes, the vortex and the ever-changing bubble patterns moving up and down the dropshaft or multiple dropshafts provide the viewer with a mesmerizing as well as entertaining display. Another objective of the present invention is to make an easily scalable vortex water feature using very simple components thereby minimizing the costs to produce, maintain, and operate.

The present invention is a dynamic vortex water feature having an upper vessel and a lower vessel for containing water. A vertical pipe extends from the bottom of the upper vessel and is attached at a lower end to a sump pump that is located interior to the lower vessel. A vortex generator is attached at an opening of the upper vessel and is in fluid communication with a transparent dropshaft. The dropshaft is approximate the length of and parallel to the vertical pipe. The sump pump pumps water from the lower vessel up the vertical pipe and into the upper vessel. Water flows out the vortex generator entering the dropshaft tangentially thereby creating a spirally of the water. This spirally leads to a variety of visually pleasing vortex and air induced bubble patterns that constantly change during the filling and emptying cycle of the water feature. There is a valve attached at the lower end of the dropshaft that enables adjustment of the discharge rate of the dropshaft and the cycle time of the water feature.

### BRIEF DESCRIPTION OF THE DRAWINGS

The above description and other objects, advantages, and features of the present invention will be more fully understood and appreciated by reference to the specification and accompanying drawings, wherein:

FIG. 1 is a perspective view of the vortex dropshaft water feature of the present invention.

FIG. 2 is an exploded perspective view of the vortex generator portion of the water feature of the present invention.

FIG. 3 is a cross-sectional plan view of FIG. 1 taken at line 3-3 depicting the flow of water through the water feature of the present invention.

FIG. 4 is a cross-sectional exploded view of the vortex generator portion of the water feature as shown in FIG. 2 taken at line 4-4.

FIG. 5 is a cross-sectional view of FIG. 4 taken at line 5-5 depicting the creation of a vortex from the channeling of water into the vortex generator.

FIG. 6a-6e depict a sampling of bubble patterns displayed within the dropshaft of the present invention.

FIG. 7 is a perspective view of an alternate embodiment of the present invention.

FIG. 8 is a perspective view of another alternate embodiment of the present invention.

FIG. 9 is a perspective view of another alternate embodiment of the present invention.

FIG. 10 is a cross-sectional view of FIG. 9 taken at line 10-10 depicting an alternate vortex generator of the present invention.

DRAWING ELEMENT NUMBERS:

| | |
|---|---|
| 100 | Vortex Dropshaft Water Feature |
| 101 | Water Feature Enclosure |
| 102 | Upper Vessel |
| 103 | Enclosure Opening |
| 104 | Lower Vessel |
| 106 | Vertical Pipe |
| 108 | Sump Pump |
| 110 | Check Valve |
| 112 | Vortex Generator |
| 114 | Dropshaft |
| 116 | Elbow |
| 118 | Throttling Valve |
| 119 | Discharge Tube |
| 120 | Re-Entry Point |
| 201 | Attachment Plate |
| 202 | Sluice Gate |
| 204 | Approach Channel |
| 206 | Outside Wall |
| 207 | Tangential Inlet Opening |
| 208 | Inside Wall |
| 210 | Channel Base |
| 212 | Nut |
| 214 | Slot |
| 216 | Entry Tube |
| 302 | Water |
| 304 | Gate Opening |
| 306 | Air Baffles |
| 402 | Attachment Pin |
| 404 | Upper Vessel Opening |
| 502 | Vortex Center |
| 602 | Bubble Pattern |
| 702 | Flow Control Valve |
| 704 | Cross Fitting |
| 710 | Downspout |
| 912 | Alternate Vortex Generator |
| 914 | Light Bar |

### DETAILED DISCUSSION OF THE PREFERRED EMBODIMENTS

Referring to the figures, like elements retain their indicators throughout the several views.

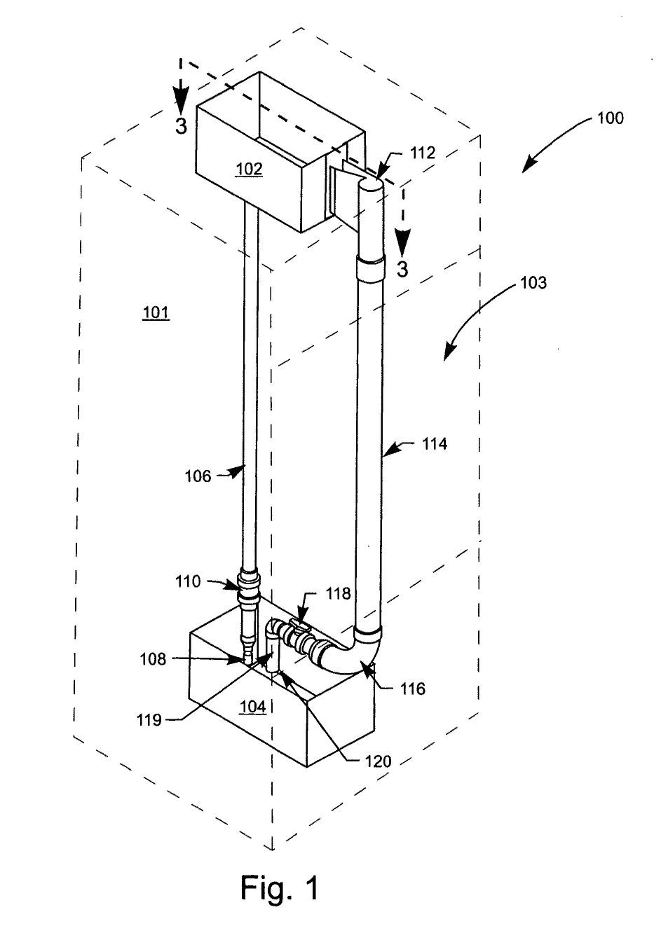

FIG. 1 is a perspective view of Vortex Dropshaft Water Feature 100 (hereinafter “Water Feature 100”) of the present invention. Water Feature Enclosure 101 (shown in phantom) functions to house and cover the necessary components of Water Feature 100 while only displaying Dropshaft 114. Water Feature Enclosure 101 can be of any configuration chosen to fit the application. For example, for a corner, it may be desirable to have Water Feature Enclosure 101 in an angular configuration fitting snugly into a corner. While for some applications it may be desirable to have Water Feature Enclosure 101 extend from the floor to the ceiling of a room with Dropshaft 114 located at a level aesthetically pleasing to the viewer. It has also been contemplated by the present inventors to have Water Feature 100 built into a structure, similar to some large fish tanks, thereby eliminating the need for any enclosure.

Enclosure Opening 103 (shown in phantom) of Water Feature Enclosure 101, exposes Dropshaft 114. Dropshaft 114 is a clear, rigid tube that allows the viewer to easily view the vortex and bubble patterns created within Water Feature 100 as Dropshaft 114 continuously fills and empties. Water Feature Enclosure 101 is preferably constructed from a rigid material such as hardwood, plywood, particle board or plastic that can be easily covered with an attractive dark coating such as paint or powder coating. A contrasting dark coating is preferred behind Dropshaft 114 allowing clear Dropshaft 114 and its ever changing contents to be more clearly viewed. In most applications, changing lighting can be added within Enclosure Opening 103 and along Dropshaft 114 for added entertainment. One contemplated option includes an LED light bar (not shown) parallel to and spanning the length of Dropshaft 114 that changes colors as the water level and bubble patterns vary.

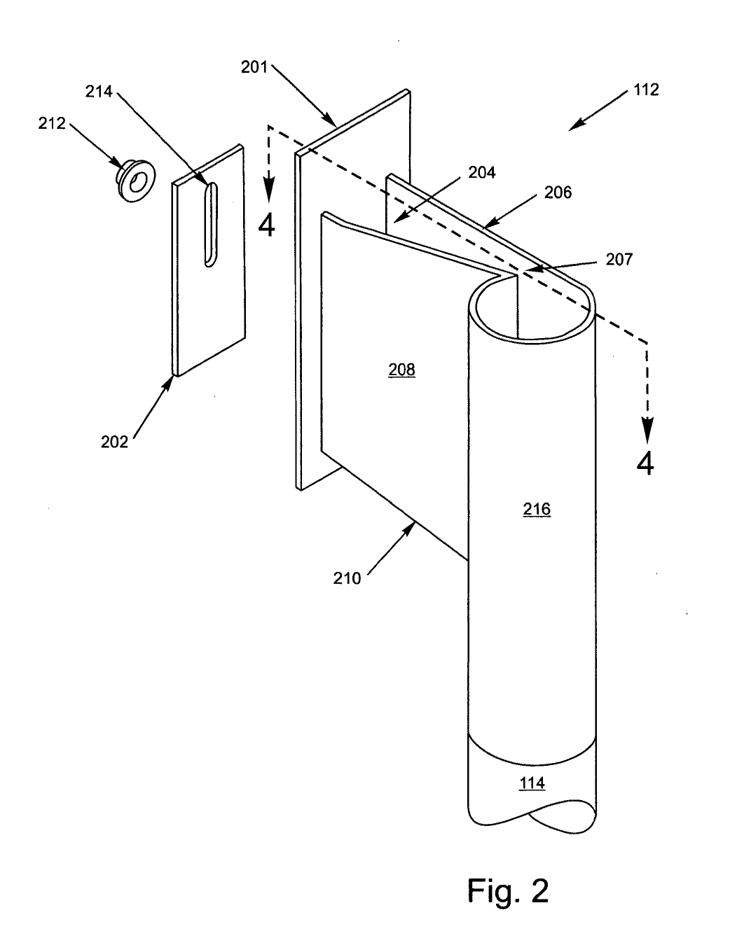

Sump Pump 108 pumps water from Lower Vessel 104 upward through Vertical Pipe 106 to Upper Vessel 102. Vertical Pipe 106 is approximately the same height as Dropshaft 114, but is not necessarily clear. For example, Vertical Pipe 106 can be a length of plastic pipe such as PVC since it is usually not visible to the viewer. As the water begins to fill Upper Vessel 102, it also begins to exit Upper Vessel 102 through Vortex Generator 112 and into attached Dropshaft 114. Vortex Generator 112 (detailed in FIG. 2) is a means of introducing the water into the inside edge of Drop Shaft 114, thereby creating a spiraling path and ultimately the visually desired vortex. Elbow 116 is attached to the base of Dropshaft 114 directing the water through Throttling Valve 118 and finally re-entering Lower Vessel 104 at Re-Entry Point 120. In the preferred embodiment, Elbow 116 is a sweep angle elbow. Sweep elbows have a larger radius than a standard plumbing elbow and feature smooth, gradual bends to help maintain flow rates and reduce energy losses.

Throttling Valve 118 is a user adjustable valve that restricts the return flow of the water into Lower Vessel 104, thus causing backwater or tail water to rise up Dropshaft 114 as water elevations change between Upper Vessel 102 and Lower Vessel 104. Throttling Valve 118 is preferably a full-port valve with the open position ranging from zero degrees (fully open) to 90 degrees (fully closed) whose size is approximately half that of the diameter of Dropshaft 114. The function of Throttling Valve 118 is to create energy loss sufficient to cause the plunge point of the water entering Dropshaft 114 from Upper Vessel 102 to vary from the lower end of Dropshaft 114 to the upper end as flow varies. For example, for a more lingering view of the development of the vortex created within Water Feature 100, Throttling Valve 118 can be adjusted to a more closed position. In this case, Dropshaft 114 will fill more quickly as there will be minimal discharge flow through Throttling Valve 118 and, as a result, will empty more slowly making the filling cycle shorter and the emptying cycle longer. Conversely, by opening Throttling Valve 118 to a more open position, Water Feature 100 will display a longer Dropshaft 114 filling cycle as maximum water is discharging through Throttling Valve 118, but will empty quickly as soon as Lower Vessel 104 is depleted sufficiently to turn Sump Pump 108 off. The degree of closure of Throttling Valve 118 is an adjustable user preference.

As is typical with sump pumps, Sump Pump 108 is controlled by a simple float switch (not shown) that turns Sump Pump 108 on when it floats to a high or “on” level and then turns Sump Pump 108 off when the water level decreases and the float switch drops to a low or “off” level. Preferably, Sump Pump 108 is equipped with an on-off float switch with a range of at least seven inches. A standard 120-volt, 15 amp electrical outlet is adequate for pumps up to one horsepower, which is sufficient for Dropshaft 114 diameters up to approximately six inches.

In the preferred embodiment, Check Valve 110 is installed near the lower end of Vertical Pipe 106 to prevent reverse flow when Sump Pump 108 is turned off.

The location of Re-Entry Point 120 is also a user adjustable element of Water

Feature 100. If the audible sound of water splashing or falling is desired, Discharge Tube 119 can be either removed or shortened, thereby Re-Entry Point 120 is above the water surface in Lower Vessel 104. However, for a more quiet water feature, Discharge Tube 119 can be of a longer length making Re-Entry Point 120 fall below the surface of the water in Lower Vessel 104 significantly reducing sounds associated with running or falling water.

In the preferred embodiment, Upper Vessel 102 and Lower Vessel 104 are constructed from light-weight, durable plastic. However, the shape and construction materials for Upper Vessel 102 and Lower Vessel 104 are relatively unimportant. They must merely contain enough water to produce sufficient variation in water volume over a flow cycle, to accommodate sump pump operation, and to allow Upper Vessel 102 to drain in a reasonable time period (approximately one minute or less) following pump shutdown. A flow cycle is defined as the filling and emptying of Dropshaft 114. For example, a four inch diameter Dropshaft 114 requires Lower Vessel 104 accommodate a volume of approximately 30 gallons of water while Upper Vessel 102 must be able to contain a volume of approximately 25 gallons of water.

One of the features of the present invention is that it is scalable to accommodate small to large installations. Components, such as Sump Pump 108, Throttling Valve 118, and electrical requirements for a Dropshaft 114 larger than six inches in diameter would normally be selected and designed on a site-by-site basis to ensure that adequate electrical power is available for Sump Pump 108 and that Throttling Valve 118 is sized to operate at a setting that will provide reliable and repeatable performance.

Once the designer selects the diameter for Dropshaft 114, other components for Water Feature 100 are sized based on hydraulic model studies, which conform to Froude modeling laws. Froude models are dominated by gravitational forces—the dominant forces in a vortex dropshaft. Pertinent relationships, based on Froude model laws and physical model tests conducted at the Iowa Institute for Hydraulic Research (IIHR) in 1982-1983, are listed below. Note that the subscript, p, refers to the prototype (this is what is being designed), while the subscript, m, refers to the model tested at IIHR.
Scale Ration, Lᵣ=Defining prototype dimension/Defining model dimension. The defining dimensions are Dropshaft 114 diameters for both prototype (Dₚ) and Model (Dₘ).
Flow Ratio: Qₚ=Qₘ/Lᵣ^{5/2}
Sluice Gate 202 width, B=0.72 Lᵣ
Tangential Inlet Opening 207: e=0.24 Lᵣ
Minimum Dropshaft 114 height, H=15Dₚ
Taper angle of Inside Wall 208 of Vortex Generator 112˜17 degrees
Drop angle, α, of Channel Base 210 of Vortex Generator 112˜27 degrees
Ratio of radius of 90 degree bend of Elbow 116 to Dropshaft 114 diameter: R/Dₚ=2.5
Sump Pump 108 horsepower: HP=62.4QₚHₚ/(550E), where E is pump efficiency (typically about 0.80), Qₚ is the prototype pumped flow rate in cubic feet per second (one cubic foot per second, cfs—448.83 gallons per minute, gpm), and Hₚ is the height water is pumped in feet. Hₚ depends on the difference in water surface levels between Upper Vessel 102 and Lower Vessel 104, which is mostly described by H.

From the model tests at IIHR, a 16.8 degree taper and a 27.5 degree drop were found to comprise a near optimal configuration. The 27.5 degree drop or slope was observed to be the approximate value required to allow fluid particles in the incoming slotted jet stream to fall far enough during one revolution that they do not mix with the incoming jet. Geometric configurations approximating these values also seem to perform quite satisfactorily for the purposes of the present invention, i.e., these two angles do not need to be exact to produce the desired bubble patterns. Note that the present inventors are not attempting to optimize energy loss in the dropshaft as is one of the major goals associated with the IIHR model study, but to use the general model guidelines as an effective way to produce a vortex display.

Hydraulic modeling scales have been established based on physical model tests and hydraulic modeling similarity laws that permit each component of Water Feature 100 to be sized using a Windows® based computer program once the inside diameter of Dropshaft 114 is selected. These dimensions and specifications are guides for selecting off-the-shelf commercially available components minimizing the need for costly custom components.

FIG. 2 is an exploded perspective view of Vortex Generator 112 of Water Feature 100 of the present invention. Water enters Vortex Generator 112 from Upper Vessel 102 through Gate Opening 304 (not shown). Attach Plate 201 is fixedly attached to an outer wall of Upper Vessel 102 and has an opening coinciding with Gate Opening 304. Attach Plate 201 has an Attachment Pin 402 (not shown) that extends through Upper Vessel 102 and through Slot 214 of Sluice Gate 202. In this preferred embodiment, Sluice Gate 202 is located interior to Upper Vessel 102 and held in position by Nut 212 which is attached to Attachment Pin 402 (not shown) extending into Upper Vessel 102. The flow of water is increased or decreased by loosening Nut 212 and sliding Sluice Gate 202 up or down on Attachment Pin 402 according to a user preferred fill rate. In an alternate embodiment, Sluice Gate 202 is omitted and Gate Opening 304 is made larger or smaller according to the desired water flow rate for the particular application.

As water enters Approach Channel 204, the downward slope of Channel Base 210 creates the initial downward plunge of water while the angle of Inside Wall 208 directs the water toward Outside Wall 206 through Tangential Inlet Opening 207 and plunges tangentially into Entry Tube 216. Dropshaft 114 is attached to the lower portion of Entry Tube 216. The inventors have experimented with several different types of vortex generators. Although functional, many have reduced visual affects compared with the design of Tangential Inlet Opening 207 as shown in FIG. 2. An alternative to the tangential design that has been tested for this water feature is to drop the water directly out of the bottom of the upper tank. The vortex generator consists of a corkscrew baffle effect that is contained in the upper reaches of Dropshaft 114. However, the vortex generator portion of the present invention can be modified to any configuration that creates a slotted jet that enters Dropshaft 114 tangentially and with a downward-sloping velocity component.

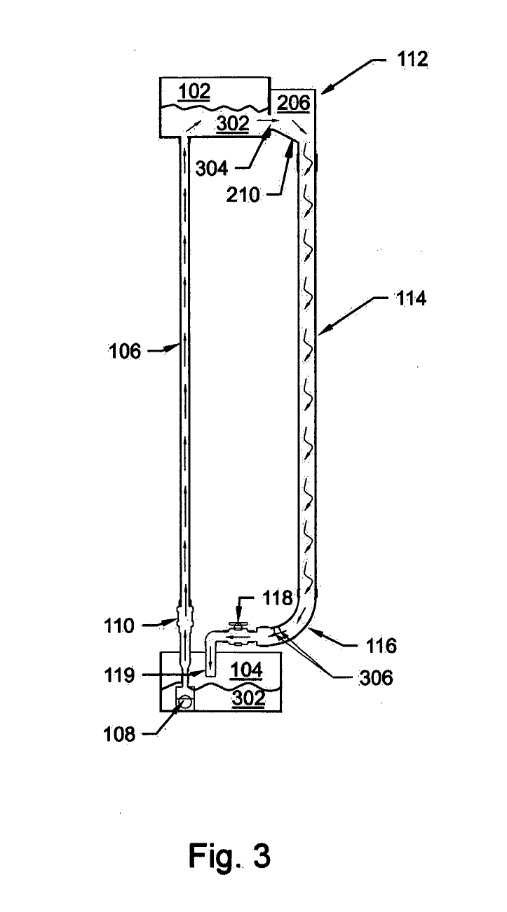

FIG. 3 is a cross-sectional plan view of FIG. 1 taken at line 3-3 depicting the flow of Water 302 through Water Feature 100. Sump Pump 108 is shown submersed in Water 302 in the bottom of Lower Vessel 104. The arrows show the flow of Water 302 pumped upward by Sump Pump 108 through Check Valve 110 and Vertical Pipe 106 thereby filling Upper Vessel 102. Sump Pump 108 pumps until a set volume of water is pumped out of Lower Vessel 104 then shuts off. As soon as Water 302 enters Upper Vessel 102 a stream of Water 302 begins to flow through Gate Opening 304, into Vortex Generator 112 and begins spiraling downward along the inner wall of Dropshaft 114 ultimately creating a visible vortex within Dropshaft 114.

In the preferred embodiment, as Water 302 falls into Elbow 116, it passes over Air Baffles 306. The space created behind the Air Baffles 306 catches random amounts of air prior to filling Dropshaft 114 that eventually escape up Dropshaft 114 as it fills and ultimately empties. These air bubbles tend to travel up the center of Dropshaft 114, giving added entertainment value to the display as the size, shape, and quantity of air bubbles vary with each cycle.

As previously discussed, the emptying and filling rates of Dropshaft 114 and the length of the system cycle are controlled by adjusting Throttling Valve 118. For a more leisurely or longer cycle, Throttling Valve 118 is adjusted to a more open position. Alternately, for a more exciting and shorter cycle, Throttling Valve 118 can be adjusted to a more closed position. The user adjustability of Throttling Valve 118 allows Water Feature 100 to be adjusted depending upon the desired display.

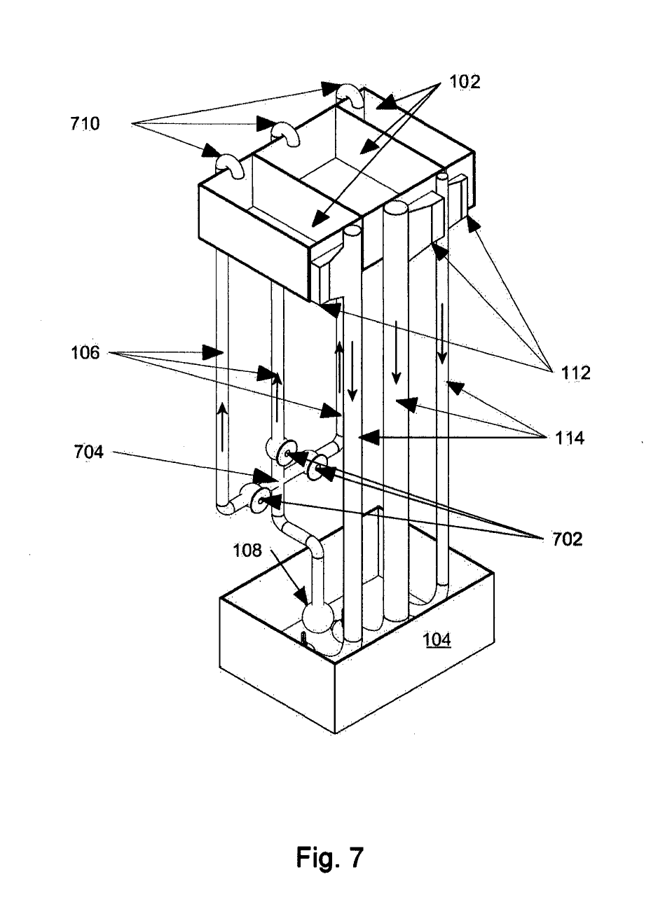

Finally, Water 302 leaving Throttling Valve 118 falls through Discharge Tube 119 and re-enters Lower Vessel 104 at Re-entry Point 120. As previously discussed, some users prefer a splashing or waterfall sound within water features. To create this affect, the user can simply use a shorter Discharge Tube 119 or remove it completely so that Water 302 splashes into Lower Vessel 104. However, if a more calm or quiet feature is preferred; a longer Discharge Tube 119 can be used that maintains re-entry into Lower Vessel 104 below the surface of Water 302. In some configurations of the display as shown in FIG. 7, Dropshaft 114 is extended to the bottom of the lower vessel, thus eliminating the need for Discharge Tube 119.

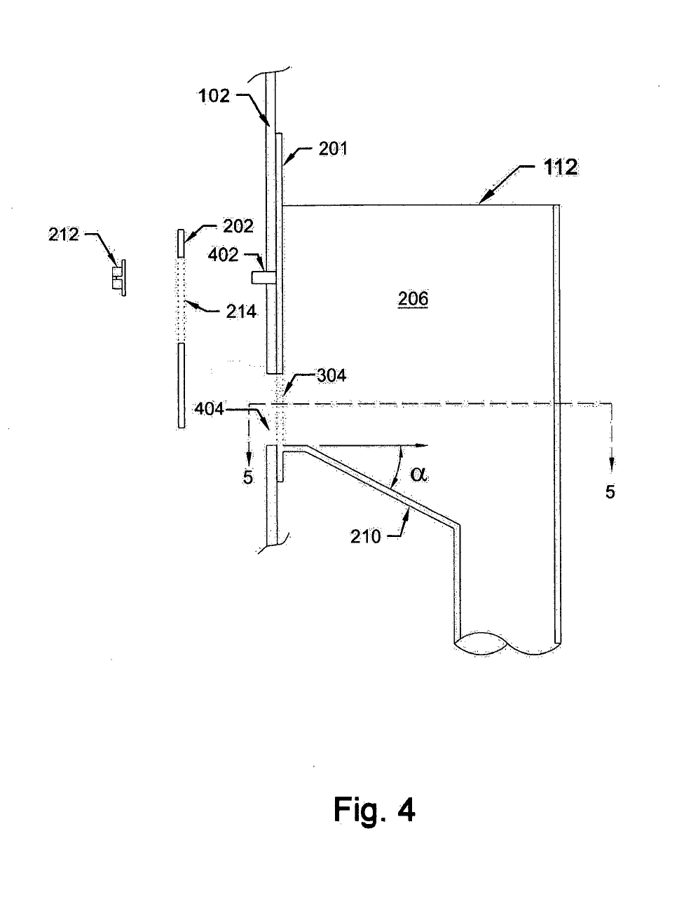

FIG. 4 is a cross-sectional exploded view of Vortex Generator 112 of Water

Feature 100 as shown in FIG. 2 taken at line 4-4. As shown in FIG. 4, Gate Opening 304 in Attachment Plate 201 coincides with Upper Vessel Opening 404 disposed in Upper Vessel 102. Sluice Gate 202 is adjusted to control the amount of fluid head in Upper Vessel 102 and works in conjunction with Throttling Valve 118 to control how quickly Dropshaft 114 empties.

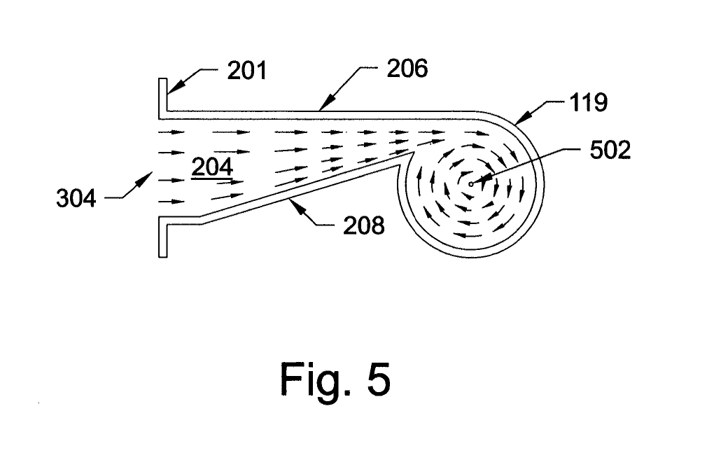

FIG. 5 is a cross-sectional view of FIG. 4 taken at line 5-5 depicting the creation of a vortex within Dropshaft 114 from the channeling of Water 302 into Vortex Generator 112. As Water 302 enters Approach Channel 204 of Vortex Generator 112 through Gate Opening 304 from Upper Vessel 102, Water 302 is directed toward Outside Wall 206 by angular Inside Wall 208 which narrows Approach Channel 204. The angle of Inside Wall 208 initiates the tangential entry of Water 302 into Dropshaft 114. As a result, the desired vortex is formed with Vortex Center 502 staying proximate to the center of Dropshaft 114. In the preferred embodiment, Inside Wall 208 is tapered at an angle of approximately 17 degrees.

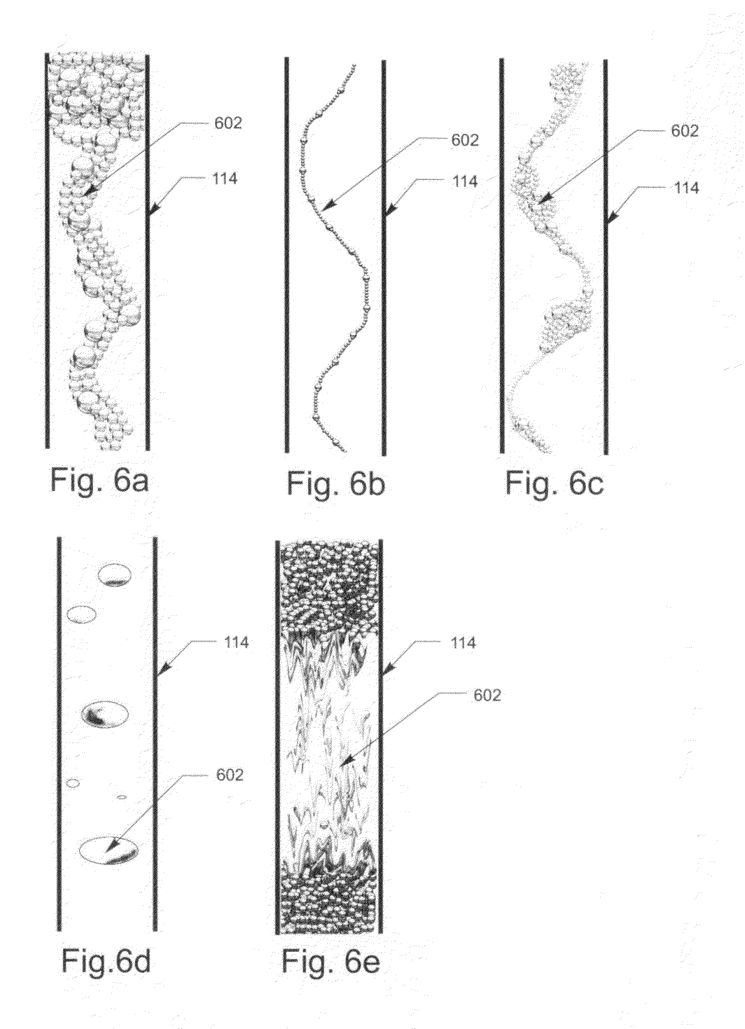

FIG. 6a-6e are examples of some of the patterns Bubbles 602 display within Dropshaft 114 of the present invention.

FIG. 6a is an example of the initially formed vortex that makes a pattern of Bubbles 602 that resembles a “tornado” in shape and movement. As the water begins to exit Dropshaft 114, the vortex stabilizes somewhat and creates a thinner, finer pattern that looks more like a “rope”, as shown in FIG. 6b, that extends from near the top of Dropshaft 114 to the bottom.

FIG. 6c is an example of another pattern of Bubbles 602 exhibited in Dropshaft 114 that often begins from entrapped air within Air Baffles 306 that begins to escape as the level of water in Dropshaft 114 begins to recede. The pattern of Bubbles 602 shown in FIG. 6c has the look of a “snake” as it swims up Dropshaft 114.

As the “snake” of FIG. 6c begins to separate, the larger Bubbles 602 float upward and have the appearance of “butterflies” as depicted in FIG. 6d. And, finally, FIG. 6e is a configuration of Bubbles 602 that look very much like a “salmon run” as Bubbles 602 begin to blur and lose definition within the center of the column of water.

The patterns of Bubbles 602 shown in FIG. 6a-6e are only a few examples of the variety of bubble patterns displayed within Dropshaft 114 during a cycle. As one can appreciate the generalized characteristics of flowing water and entrained air, many other unique patterns will also be enjoyed over several cycles of the Vortex Water Feature 100 of the present invention.

There are several ways to provide water to Vortex Generator 112 to create the displayed water patterns. In the preferred embodiment of the present invention, there are two tanks—one at the top, Upper Vessel 102, and one at the bottom, Lower Vessel 104, of Dropshaft 114. As the water is pumped from Lower Vessel 104 to Upper Vessel 102, the increased level of water in Upper Vessel 102 increases the flow of water through Vortex Generator 112 into Dropshaft 114. The increased flow causes the water to rise to the top of Dropshaft 114 generating the different bubble and flow patterns. When the sump pump shuts off the water level in Upper Vessel 102 slowly decreases causing the water level in Dropshaft 114 to decrease and the bubble and flow patterns to continually change. This is the simplest approach and requires only one moving part and that is Sump Pump 108 turning on and off.

FIG. 7 depicts an alternate embodiment of the present invention having multiple Dropshaft 114 displays with a separate Upper Vessel 102 for each Dropshaft 114. Vertical Pipe 106 is separated into three pipes by Cross Fitting 704. Each of the three pipes have an in-line Flow Control Valve 702 used to direct the water into each Upper Vessel 102 associated with each Dropshaft 114. Sump Pump 108 now can run all the time and the water level and the patterns of Bubbles 602 in each Dropshaft 114 display tube is controlled by the amount of water allowed into each Upper Vessel 102 by Flow Control Valve 702 and the adjustment of Throttling Valve 118. In the embodiment shown in FIG. 7, each Flow Control Valve 702 is an electrically operated on/off diaphragm valve with manually adjustable flow control.

The operation of the single Dropshaft 114 model shown in FIG. 1 and the multiple Dropshaft 114 model shown in FIG. 7 are essentially the same except there is an Upper Vessel 102 for each Dropshaft 114. Each Flow Control Valve 702 is used to control which tank or tanks are being filled as predetermined by an electronic controller (not shown). The maximum height of water desired in each Dropshaft 114 determines the setting of Flow Control Valve 702 for that particular Dropshaft 114.

In FIG. 7, water enters each Upper Vessel 102 through Downspout 710 attached to the upper end of each Vertical Pipe 106.

In this alternate embodiment, each Dropshaft 114 can be the same diameter or different depending on the preference of the user. This alternate, multiple vortex dropshaft water feature is adjustable to create an even more dynamic display as the added flow control enables each Dropshaft 114 to empty and fill at differing rates..

The inventors have also contemplated other methods to control the water, the flow, and bubble patterns moving up and down Dropshaft 114 display tube or tubes. In an alternate embodiment, control valves vary the flow of water directly into the vortex generator of each Dropshaft 114 and eliminate the top tank or tanks completely. Although using a control valve to adjust the flow directly into Vortex Generator 112 is a more expensive approach, it does eliminate the need for a tank on top of the display for each Dropshaft 114 thereby adding simplicity to the overall design and minimizing size.

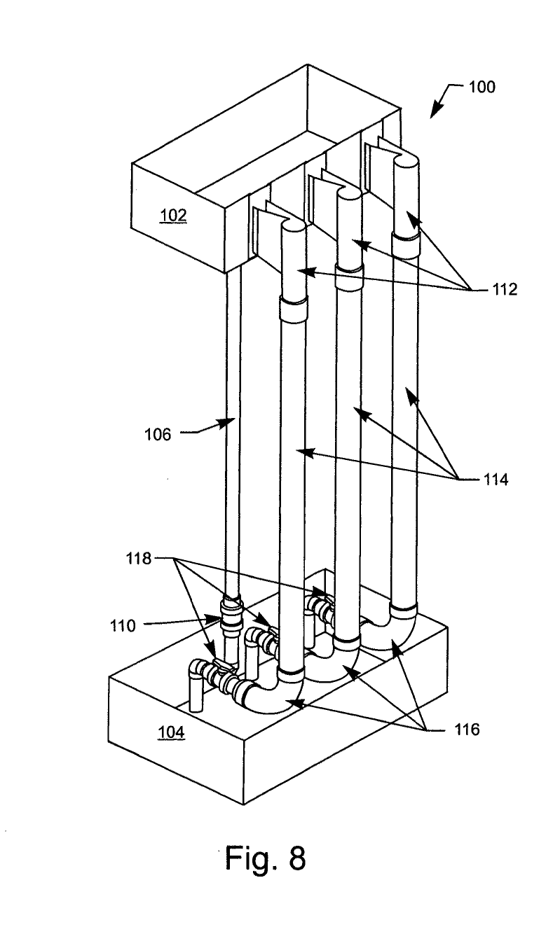

FIG. 8 depicts another alternate embodiment of the present invention having a single Upper Vessel 102, a single Lower Vessel 104, and three Dropshaft 114 displays. Upper Vessel 102 and Lower Vessel 104 are sized to accommodate adequate water to fill all three Dropshaft 114 display tubes. Although each Dropshaft 114 in FIG. 8 appears to be the same diameter, each can also be different.

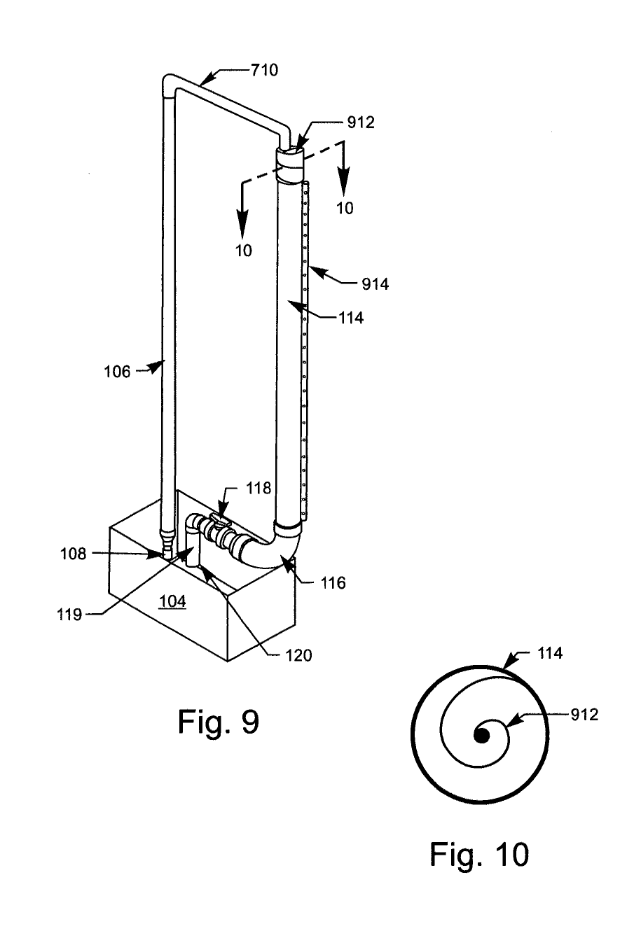

FIG. 9 is a perspective view of an alternate embodiment of the present invention with Upper Vessel 102 omitted. Downspout 710 returns Water 302 directly into Alternate Vortex Generator 912 positioned within Dropshaft 114. Alternate Vortex Generator 912 has an internal helical shape and is positioned in the upper portion of Dropshaft 114.

As Water 302 enters Alternate Vortex Generator 912 it is directed in a spiral downward and along the inside wall of Dropshaft 114 initiating the desired spiraling vortex display within Dropshaft 114. In this alternate embodiment, Sump Pump 108 is alternated between an on and off state with a common electrical timer (not shown) that is adjusted such that Sump Pump 108 runs until Water 302 essentially fills Dropshaft 114 then turns off. As Dropshaft 114 nears empty, Sump Pump 108 will turn back on beginning the cycle again.

The current inventors have also contemplated cycling Water 302 with an electrically controlled diversion valve (not shown) at the output of Sump Pump 108. At the beginning of a cycle, the diversion valve is positioned such that Water 302 is pumped up Vertical Pipe 106 and through Downspout 710 and into Dropshaft 114. When Dropshaft 114 reaches a desired level the diversion valve switches to a second position diverting Water 302 into Lower Vessel 104 until Dropshaft 114 is empty or near empty. In this embodiment, Sump Pump 108 runs continuously. Throttling Valve 118 can also be adjusted to speed or slow the filling and emptying of Dropshaft 114 as discussed in the previous embodiments of the present invention to create a variety of mesmerizing displays.

FIG. 9 depicts the general placement of Light Bar 914 spanning the length of Dropshaft 114. Light Bar 914 is a rigid bar with an array of evenly spaced LED's from top to bottom fixedly attached to Dropshaft 114. Preferrably the LED's are spaced approximately one inch apart, however, spacing is a user preference determined by the size of Dropshaft 114 and desired illuminating effect. In this alternate embodiment, the LED's are various colors and sequence via a controller (not shown). However, any light source, constant or sequencing, will enhance the vortex display.

In this alternate embodiment which eliminates Upper Vessel 102, the overall size of the water feature can be made significantly smaller for desk or smaller home displays.

FIG. 10 is a cross-sectional view of FIG. 9 taken at line 10-10 of Alternate Vortex Generator 912 depicting the spiraling path Water 302 follows as it leaves Downspout 710 and enters Dropshaft 114. It has also been contemplated to use Alternate Vortex

Generator 912 with an Upper Vessel 102 in a configuration similar to FIG. 1 such that Alternate Vortex Generator 912 and Dropshaft 114 are positioned below Upper Vessel 102 with Water 302 exiting the bottom of Upper Vessel 102.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

I claim:

1. A dynamic vortex water feature, comprising:
an upper vessel for containing a quantity of water and having an opening on a side wall;
a lower vessel positioned below said upper vessel for containing said water and a sump pump;
a vertical pipe having an upper end in fluid communication with said upper vessel and a lower end fixedly attached to said sump pump;
a transparent dropshaft essentially parallel to said vertical pipe having a first end in fluid communication with said upper vessel at said opening and a second end opposite said first end;
a throttling valve; and
an elbow section of piping having an approximate ninety degree curve disposed between said second end of said dropshaft and said throttling valve,
wherein said sump pump pumps said water from said lower vessel upward through said vertical pipe into said upper vessel, a flow of said water flows from said upper vessel through said opening and enters said dropshaft tangentially proximate said first end along an interior wall of said dropshaft thereby creating a vortex of said water as said water fills said dropshaft, said water returns to said lower vessel through said elbow section and said throttling valve wherein said throttling valve is adjusted by a user to control a discharge rate of said dropshaft, thereby creating a variable array of bubble patterns.

2. The dynamic vortex water feature of claim 1, further comprising:
a vortex generator disposed between said opening and said first end of said dropshaft and fixedly attached to said side wall of said upper vessel, said vortex generator having a vertical outside wall, a vertical inside wall, and a channel base extending from said side wall and spanning a lower outside wall edge and a lower inside wall edge, wherein said inside wall tapers toward said outside wall, and said channel base slopes slightly downward such that said water is directed downward and toward said outside wall thereby initiating tangential entry of said water into said first end of said dropshaft.

3. The dynamic vortex water feature of claim 1, further comprising, a check valve disposed in said vertical pipe such that when said sump pump is disabled, said check valve blocks said water from flowing downward into said lower vessel.

4. The dynamic vortex water feature of claim 1, wherein said elbow section of piping further comprising at least one air baffle attached to an interior surface of said curve of said elbow section of piping such that a quantity of air contained in said water accumulates and ultimately escapes up said dropshaft adding to said variable array of bubble patterns.

5. The dynamic vortex water feature of claim 1, further comprising a sluice gate slideably attached to said side wall interior to said upper vessel and approximate said opening, wherein said sluice gate is slid upward increasing said flow of said water through said opening and slid downward to decrease said flow of said water through said opening thereby controlling a fill rate of said dropshaft.

6. The dynamic vortex water feature of claim 1, further comprising a light bar for illuminating said dropshaft, said light bar is fixedly attached and parallel to said dropshaft.

7. The dynamic vortex water feature of claim 1, wherein said dropshaft is a plastic tube.

8. The dynamic vortex water feature of claim 1, wherein said dropshaft is a glass tube.

9. A dynamic vortex water feature, comprising:
an upper vessel for containing a quantity of water and having at least one opening on a side wall;
a lower vessel positioned below said upper vessel for containing said water;
a sump pump disposed within said lower vessel;
a vertical pipe having a length and fixedly attached to and in fluid communication with said upper vessel at a first end and said sump pump at a second end opposite said first end;
at least one transparent dropshaft having approximate said length and essentially parallel to said vertical pipe each said dropshaft having a throttling valve at a lower end adjacent to said lower vessel; and
at least one vortex generator in fluid communication with and fixedly attached to said side wall of said upper vessel approximate said at least one opening, each said vortex generator having a tangential opening in fluid communication with an upper end of said at least one dropshaft,
wherein, said sump pump pumps said water from said lower vessel upward through said vertical pipe into said upper vessel, said water flows from said upper vessel through each said vortex generator, out said tangential opening of each said vortex generator, and enters each said dropshaft attached to each said vortex generator tangentially along an interior wall of each said dropshaft thereby creating a vortex of said water as said water fills each said dropshaft, said water returns to said lower vessel through each said throttling valve, each said throttling valve is adjusted by a user to independently control a discharge rate of each said dropshaft attached to each said vortex generator.

10. The dynamic vortex water feature of claim 9, further comprising, a check valve disposed in said vertical pipe such that when said sump pump is off, said check valve blocks said water from flowing downward into said lower vessel.

11. The dynamic vortex water feature of claim 9, further comprising, at least one elbow section of piping having an approximate ninety degree curve connected between each said throttling valve and each said dropshaft, each said elbow section having at least one air baffle attached to an interior surface approximate said curve such that a quantity of air contained in said water accumulates and ultimately escapes up each said dropshaft as a visible bubble pattern.

12. The dynamic vortex water feature of claim 9, further comprising a light bar for illuminating said dropshaft, said light bar is fixedly attached and parallel to said dropshaft.

13. The dynamic vortex water feature of claim 9, wherein each said dropshaft has a different diameter.

14. A dynamic vortex water feature, comprising:
at least one upper vessel for containing a quantity of water and having an opening on a side wall;
a lower vessel positioned below each said upper vessel for containing said water;
a sump pump disposed within said lower vessel;
at least one vertical pipe having a length and in fluid communication with said sump pump at a first end, each said vertical pipe having a flow control valve disposed along said length with a second end opposite said first end in fluid communication with each said upper vessel;
at least one transparent dropshaft having approximate said length and essentially parallel to each said vertical pipe, each said dropshaft having a throttling valve at a lower end adjacent to said lower vessel; and
at least one vortex generator in fluid communication with and fixedly attached to said side wall of each said upper vessel approximate each said opening, each said vortex generator having a tangential opening in fluid communication with an upper end of each said dropshaft,
wherein, said sump pump pumps a flow of said water from said lower vessel upward through each said vertical pipe into each said upper vessel, said flow of said water is controlled by said flow control valve of each said vertical pipe, said water flows from each said upper vessel through each said vortex generator, through said tangential opening of each said vortex generator, and said water enters each said dropshaft attached to each said vortex generator tangentially along an interior wall of each said dropshaft thereby creating a vortex of said water as said water fills each said dropshaft, said water returns to said lower vessel through each said throttling valve, each said throttling valve is adjusted by a user to independently control a discharge rate of each said dropshaft.

15. The dynamic vortex water feature of claim 14, wherein each said dropshaft has a different diameter.

16. The dynamic vortex water feature of claim 14, wherein each said flow control valve is an electrically operated on/off diaphragm valve with manually adjustable flow control.

17. A dynamic vortex water feature, comprising:
a lower vessel for containing a quantity of water;
a sump pump contained within said lower vessel;
a vertical pipe having an upper end in fluid communication with a downspout and in fluid communication with said sump pump at a lower end opposite said upper end;
a transparent dropshaft essentially parallel to said vertical pipe and having a first end and a second end opposite said first end;
a vortex generator attached at said first end of said dropshaft, said vortex generator having an internal helical path and in fluid communication with said downspout and said dropshaft;
an elbow section of piping having an approximate ninety degree curve in fluid communication with said dropshaft at said second end;
a throttling valve attached proximate said elbow and proximate said lower vessel;
wherein said sump pump pumps said water from said lower vessel upward through said vertical pipe into said downspout, said water flows from said downspout through said vortex generator such that said water enters said dropshaft tangentially proximate said first end along an interior wall of said dropshaft thereby creating a vortex of said water as said water fills said dropshaft, said water returns to said lower vessel through said elbow section and through said throttling valve wherein said throttling valve is adjusted by a user to control a discharge rate of said water from said dropshaft, thereby creating a variable array of bubble patterns.

18. The dynamic vortex water feature of claim 17, wherein said elbow section of piping further comprises at least one air baffle attached to an interior surface of said elbow section proximate said curve such that a quantity of air from said water accumulates and ultimately escapes up said dropshaft adding to said varying array of bubble patterns.

19. The dynamic vortex water feature of claim 17, wherein said dropshaft is a plastic tube.

20. The dynamic vortex water feature of claim 17, wherein said dropshaft is a glass tube.

21. The dynamic vortex water feature of claim 17, further comprising a light bar for illuminating said dropshaft, said light bar is fixedly attached and parallel to said dropshaft.
